(19) United States
(12) Patent Application Publication
(10) Pub. No.: US 2014/0059463 A1
(43) Pub. Date: Feb. 27, 2014

(54) ELECTRONIC DEVICE AND METHOD FOR FILE ARRANGEMENT

(71) Applicants: HONG FU JIN PRECISION INDUSTRY (ShenZhen) CO., LTD., (US); HON HAI PRECISION INDUSTRY CO., LTD., (US)

(72) Inventor: YI-HUA WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/864,229

(22) Filed: Apr. 16, 2013

(30) Foreign Application Priority Data
Aug. 24, 2012 (CN) 201210304098.0

(51) Int. Cl. G06F 3/0481

(52) U.S. Cl. CPC G06F 3/0481
USPC 715/771

(57) ABSTRACT

A file arrangement system applied in an electronic device includes a display control module, a date obtaining module. The display control module is operable to control a display unit of the electronic device to display a user interface with a date scale according to a predefined calendar. The date scale includes date marks corresponding to the calendar. The date obtaining module is operable to obtain the creation date of a selected file. The display control module is further operable to control the display unit to display the thumbnail image of the selected file in a position of the date scale where the date mark corresponds to the creation date of the selected file. An electronic device and a file arrangement system are also provided.

### BACKGROUND

1. Technical Field

The present disclosure relates to file arrangement devices and, particularly, to a file arrangement device and method capable of arranging files according to creation date of the files.

2. Description of Related Art

File folders for storing files are usually created according to user preferences or user's need. The files are arranged in the folders according to modification date or other rules, but the arrangement of the files is not intuitive, and it is not convenient for a user to find a needed file.

### BRIEF DESCRIPTION OF THE DRAWINGS

Many aspects of the present disclosure should be better understood with reference to the following drawings. The units in the drawings are not necessarily drawn to mark, the emphasis instead being placed upon clearly illustrating the principles of the present disclosure. Moreover, in the drawings, like reference numerals designate corresponding portions throughout the several views.

FIG. 1 is a block diagram of a file arrangement system in accordance with an exemplary embodiment.

FIG. 2 is a pictorial diagram illustrating a state of a user interface displayed by the file arrangement system in FIG. 1 in accordance with an exemplary embodiment.

FIG. 3 a pictorial diagram illustrating another state of the user interface displayed by the file arrangement system shown in FIG. 2 in accordance with an exemplary embodiment.

FIG. 4 is a flowchart of a file arrangement method in accordance with an exemplary embodiment.

### DETAILED DESCRIPTION

Embodiments of the present disclosure will now be described in detail, with reference to the accompanying drawings.

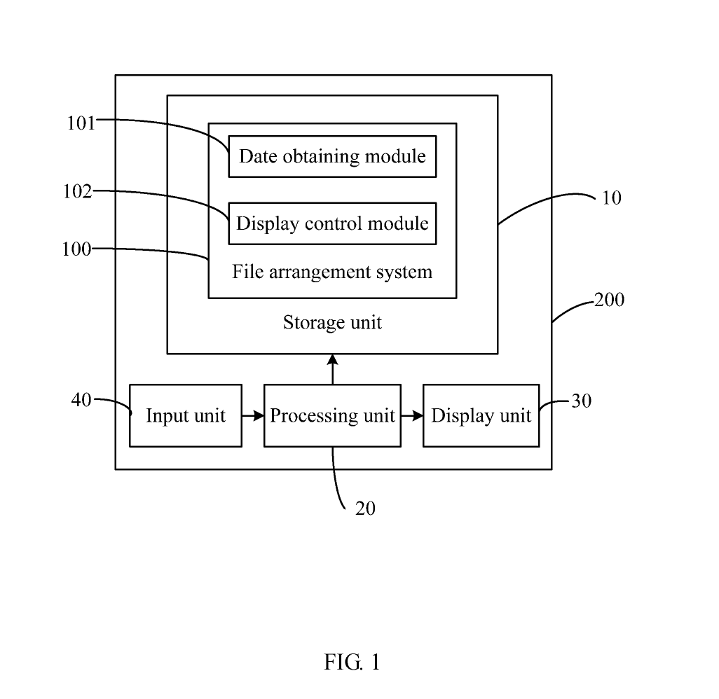

Referring to FIG. 1, in one embodiment, a file arrangement system 100 applied in an electronic device (e. g. a computer) 200 is provided. The electronic device 200 includes a storage unit 10, a processor 20, a display unit 30, and an input unit 40. In this embodiment, the input unit 40 may be a mouse, a keyboard, and the like.

The storage unit 10 may be a smart media card, a secure digital card, or a flash card. The storage unit 10 stores a number of files, such as images, audio files, and video files, each of the files includes a creation date. The storage unit 10 further stores a calendar. In the embodiment, the calendar includes day, month, and year. The storage unit 10 further stores computerized codes of the file arrangement system 100. The file arrangement system 100 includes a number of modules which are executed by the processor 20 to perform functions of the file arrangement system 100. The file arrangement system 100 includes a display control system 101 and a date obtaining module 102.

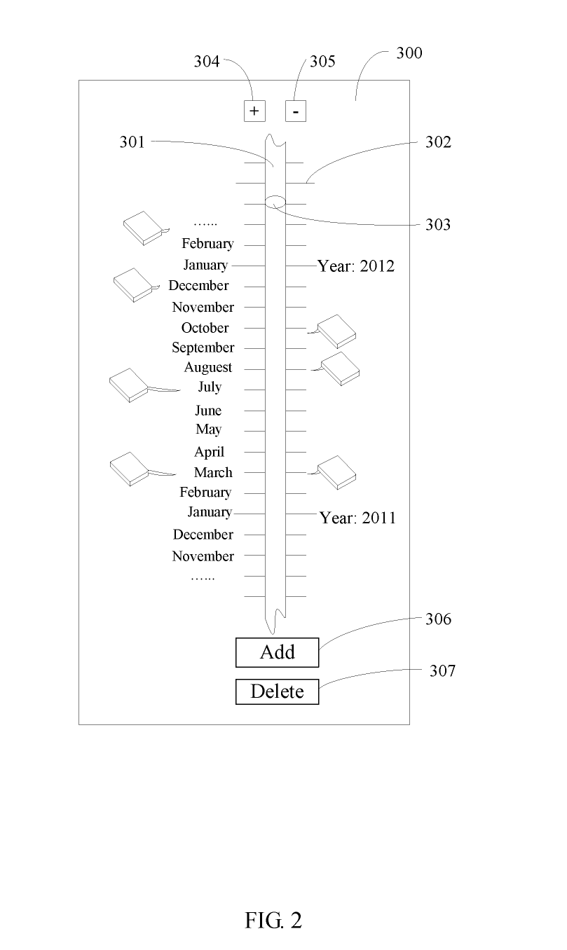

Referring to FIG. 2, the display control module 102 includes various components and/or instructions, which may be implemented by the processor 20 to obtain the calendar from the storage unit 10, and control the display unit 30 to display a user interface 300 with a date scale 301 according to the stored calendar. In this embodiment, the date scale 201 is a straight line with date marks 302, the date marks 302 correspond to years, months, and days of the stored calendar. In other embodiments, the date scale 301 may be a circular line with the date marks, or the like.

The input unit 40 is configured for users to select one or more files stored in the storage unit 10. The date obtaining module 101 includes various components and/or instructions, which may be implemented by the processor 20 to obtain the creation date of the selected files. The display control module 102 controls the display unit 30 to display the thumbnail image of each of the selected file in a position of the date scale 301 where the date mark 302 corresponds to the creation date of the selected file. For example, as shown in FIG. 2, if the processor 20 obtains a creation date of Feb. 22, 2012 for a selected file, the processor 20 controls the display unit 30 to display a thumbnail image of the selected file in a position where the date mark 302 indicates Feb. 22, 2012. In this embodiment, if one mark of the date scale 301 corresponds to more than one file, the processor 20 gathers the thumbnail images of the files into a folder, and displays the folder in the position of the mark.

The display control module 102 is further implemented by the processor 20 to scroll, magnify, and minimize the date scale 301 in response to user input. For example, the user can scroll the date scale 301 to browse the thumbnail images by scrolling a wheel of a mouse or by dragging a scrolling indicator 303 of the user interface 300.

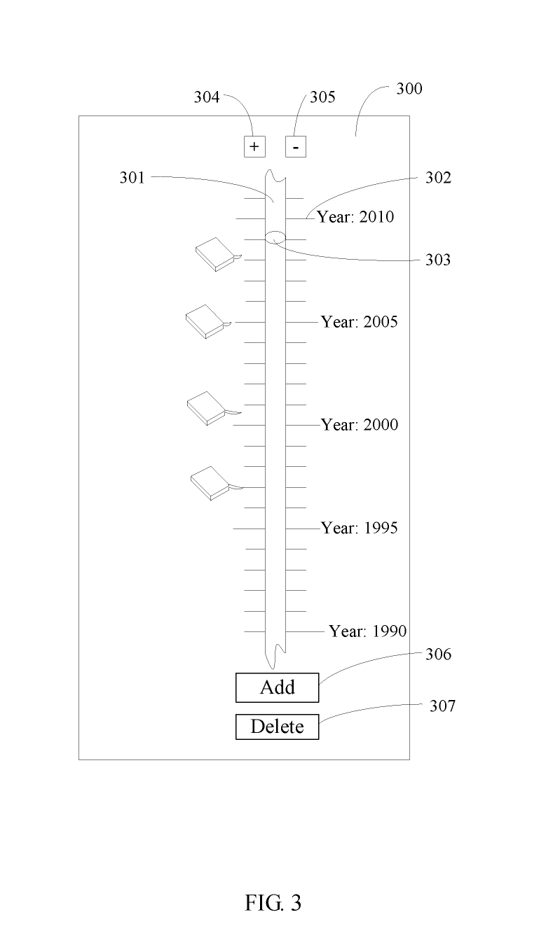

In the embodiment, the user interface 300 further includes a magnify button 304 and a shrink button 305. The magnify button 304 is used to magnify the date scale 301 to display smaller units of the date scale 301, and the shrink button 305 is used to shrink the date scale 301 to display larger units of the date scale 301. For example, if the currently displayed unit of the date scale 301 is year, shown as FIG. 3, when the magnify button 304 is clicked, the date scale 301 is magnified, and the month units may be displayed, shown as FIG. 2.

In the embodiment, the user interface 300 further includes a file adding button 306 for users to add files to the user interface 300. In detail, when the file adding button 306 is clicked, the display control module 102 is implemented by the processor 20 to control the display unit 30 to display a window for the user to select a file to be added.

In the embodiment, the user interface 300 further includes a file deleting button 307 for users to delete files from the user interface 300. In detail, if a thumbnail image of a file displayed on the date scale 301 is selected by the user, and then the file deleting button 307 is clicked, the selected file is deleted.

With such configuration, file and/or file folders are displayed intuitively according to creation date, thus it is convenient for users to find a desired file.

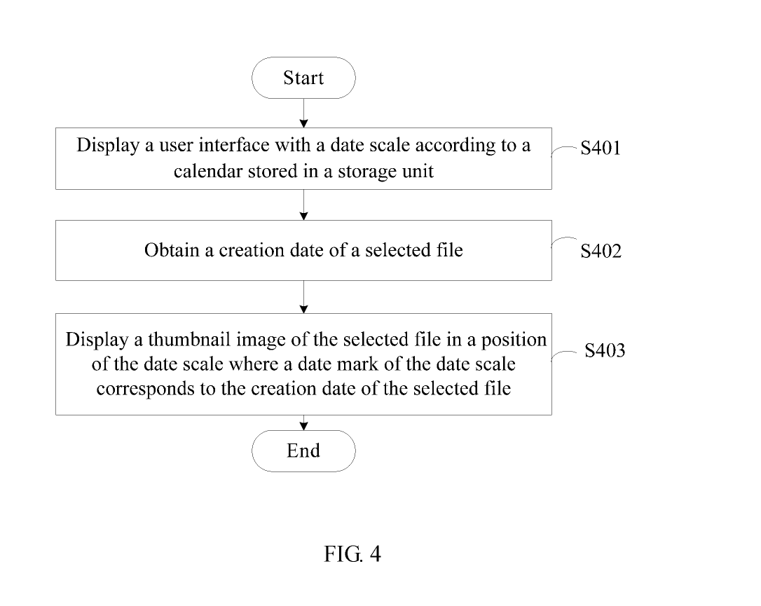

FIG. 4 is a flowchart of a file arrangement method in accordance with an exemplary embodiment.

In step S401, the display control module 102 controls the display unit 30 to display a user interface 300 with a date scale 301 according to the calendar stored in the storage unit 10.

In step S402, the date obtaining module 101 obtains the creation date of the selected files.

In step S403, the date obtaining module 10 controls the display unit 30 to display the thumbnail images of the selected files in a position of the date scale 301 where the date mark 302 corresponds to the creation date of the selected files.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computer-readable medium comprising program instructions of a file arrangement system, the file arrangement system being executed by a processor of an electronic device, the electronic device comprising a storage unit, a display unit, and a processor, the storage unit storing a plurality of files and a calendar, each of the files comprising a creation date, the file arrangement system comprising:
a display control module operable by the processor to control the display unit to display a user interface with a date scale according to the stored calendar, the date scale comprising date marks corresponding to the calendar; and
a date obtaining module operable by the processor to obtain the creation date of a selected file;
the display control module further operable by the processor to control the display unit to display the thumbnail image of the selected file in a position of the date scale where the date mark corresponds to the creation date of the selected file.

2. The computer-readable medium as described in claim 1, wherein the display control module is further operable by the processor to gather the thumbnail images of selected files which will be displayed in a same position of the date scale into a file folder.

3. The computer-readable medium as described in claim 1, wherein the display control module is further operable by the processor to scroll the date scale in response to user input.

4. The computer-readable medium as described in claim 1, wherein the display control module is further operable by the processor to magnify the date scale to display smaller units of the date scale in response to user input.

5. The computer-readable medium as described in claim 1, wherein the display control module is further operable by the processor to shrink the date scale to display larger units of the date scale in response to user input.

6. The computer-readable medium as described in claim 1, wherein the user interface comprises a file adding button for users to add a file to the user interface.

7. The computer-readable medium as described in claim 1, wherein the user interface further comprises a file deleting button for users to delete a file from the user interfaced.

8. An electronic device for file arrangement comprising:
a storage unit storing a plurality of files and a calendar, each of the files comprising a creation date;
a processor;
a display unit;
an input unit; and
a file arrangement system comprising computerized code in the form of one or more programs, which are stored in the storage unit and executed by the processor, the one or more programs comprising:
a display control module operable by the processor to control the display unit to display a user interface with a date scale according to the stored calendar, the date scale comprising date marks corresponding to the calendar; and
a date obtaining module operable by the processor to obtain the creation date of a selected file;
the display control module further operable by the processor to control the display unit to display the thumbnail image of the selected file in a position of the date scale where the date mark corresponds to the creation date of the selected file.

9. The electronic device as described in claim 8, wherein the display control module is further operable by the processor to gather the thumbnail images of selected files which will be displayed in a same position of the date scale into a file folder.

10. The electronic device as described in claim 8, wherein the display control module is further operable by the processor to scroll the date scale in response to user input.

11. The electronic device as described in claim 8, wherein the display control module is further operable by the processor to magnify the date scale to display smaller units of the date scale in response to user input.

12. The electronic device as described in claim 8, wherein the display control module is further operable by the processor to shrink the date scale to display larger units of the date scale in response to user input.

13. The electronic device as described in claim 8, wherein the user interface comprises a file adding button for users to add a file to the user interface.

14. The electronic device as described in claim 8, wherein the user interface further comprises a file deleting button for users to delete a file from the user interfaced.

15. A file arrangement method to be executed by a processor of an electronic device, the electronic device comprising a storage unit, a display unit, and a processor, the storage unit storing a plurality of files and a calendar, each of the files comprising a creation date, the method comprising:
displaying a user interface with a date scale by the processor according to a calendar stored in the storage unit, the date scale comprising date marks corresponding to the calendar;
obtaining the creation date of a selected file stored in the storage unit by the processor; and
displaying the thumbnail image of the selected files in a position of the date scale where the date mark corresponding to the creation date of the files by the processor.
